(19) United States
(12) Patent Application Publication
(10) Pub. No.: US 2019/0278743 A1
(43) Pub. Date: Sep. 12, 2019

(54) DOCUMENT CONVERSION APPARATUS, NON-TRANSITORY COMPUTER-READABLE RECORDING MEDIUM AND DOCUMENT CONVERSION METHOD

(71) Applicant: KONICA MINOLTA, INC., Tokyo (JP)

(72) Inventor: Mitsuharu HAYASAKA, Tokyo (JP)

(73) Assignee: KONICA MINOLTA, INC., Tokyo (JP)

(21) Appl. No.: 16/289,948

(22) Filed: Mar. 1, 2019

(30) Foreign Application Priority Data
Mar. 9, 2018 (JP) 2018-042605

(51) Int. Cl. G06F 16/11; G06F 21/62; G06F 17/24; G06F 16/957

(52) U.S. Cl. CPC G06F 16/116; G06F 16/9574; G06F 17/24; G06F 21/6209

(57) ABSTRACT

Provided are a document conversion apparatus for converting a document between two formats, a nom-transitory computer-readable recording medium and a document conversion method. A hardware processor of the document conversion apparatus converts a first document in first format into a second document in second format in accordance with one or more editing restrictions read from the first document, by adding attribute data representing an editing restriction to an object according to the second format created from each object in the first document. When obtaining the second document revised, the hardware processor creates a document in the first format containing objects created from objects in the revised second document, by applying either or both of an edit to each object and an edit to attribute data of the each object in the second document, to a corresponding object according to the first format created from the revised second document.

Japanese Patent Application No. 2018-042605 filed on Mar. 9, 2018, including description, claims, drawings, and abstract, the entire disclosure of which is incorporated herein by reference in its entirety.

### TECHNOLOGICAL FIELD

The present invention is directed to document conversion apparatuses, non-transitory computer-readable recording media each storing a document conversion program and document conversion methods. In particular, the present invention is directed to document conversion apparatuses for converting a first document such as an OOXML (Office Open XML) document or an ODF (OpenDocument Format) document, into a second document in another format, such as an HTML (Hyper Text Markup Language) document, and further converting the second document that was revised, in the reverse conversion direction, non-transitory computer-readable recording media each storing a document conversion program to be executed in the document conversion apparatus, and document conversion methods for use in a system including the document conversion apparatus.

### BACKGROUND

Office suite applications or applications of productivity software suite, which include a word processor, spreadsheet and so on, are popularly used now in various scenes in workplaces, classrooms and homes. Microsoft Office is one of typical office suites or productivity software suites, and contains Word, Excel and PowerPoint, where Microsoft, Word, Excel and PowerPoint are either registered trademarks or trademarks of Microsoft Corporation in the United States and/or other countries. Further, other office software suites, such as Apache OpenOffice, and their components having similar features as those of Microsoft Office applications are also in the market. Microsoft Office and Apache OpenOffice serve as an open source and were standardized by standardization organizations. A number of compatible applications supporting document formats of those office suite applications, such as OOXML and ODF, are also in the market.

As for a use of documents in the office suite application format, there are demands for a technique to convert documents created by office suite applications to another document format supported by standard web browsers, such as HTML format, for example, so that persons using a mobile terminal can read documents created by office suite applications on their mobile terminal. There are demands for another technique to convert documents created by the office suite applications to HTML format or save the documents as HTML documents so as to allow users of office suite applications to create a draft of web pages.

As an example of a technique to conduct such a document format conversion, Japanese Unexamined Patent Publication (JP-A) No. 2009-271780 discloses an electronic document conversion apparatus for conducting a document format conversion by converting an electronic document in first electronic document format supporting at least one security policy as one of the specifications of the format into an electronic document in another electronic document format (second electronic document format). The apparatus includes a hardware processor configured to perform the following processing. The hardware processor judges whether a security policy specified in the electronic document in the first electronic document format can be succeeded to the electronic document after the conversion, by using a corresponding security policy supported by the second electronic document format as one of the specifications of the format. When judging that the succession is not possible, the hardware processor judges whether the succession can be conducted by using alternative processing. The hardware processor then converts the electronic document to the second electronic document format, while specifying the security policy so that, if judging that the succession by using the corresponding security policy supported by the second electronic document format is possible, the security policy specified in the electronic document in the first electronic document format is succeeded to the electronic document after the conversion by using the security polity supported by the second electronic document format, and if judging that the succession by using the alternative processing is possible, the security policy specified in the electronic document in the first electronic document format is succeeded to the electronic document after the conversion by using the alternative processing, When judging that the succession by using the alternative processing is not possible, the hardware processor does not conduct the conversion of the electronic document to the second electronic document format.

As another example, JP-A No. 2005-010841 discloses the following document data editing system. The document data editing system includes a hardware processor configured to perform the following processing. The hardware processor converts document data in first format to document data in second format, and edits the document data in the second format to create revised document data in the second format. The hardware processor creates difference information between the document data in the second format, given by the conversion of the document data in the first format and the revised document data in the second format. The hardware processor creates revised document data in the first format by using the document data in the first format before the conversion and the difference information.

Office suite applications are configured to allow a person who is editing a document; to specify various restrictions on the document so as to prevent reviewers of the document from changing the document. For example, when an editor of a document created by an office suite application distributes the document for other persons and does not want them to change the whole or a part of the document, the editor can mark the whole or the part of the document as read-only in the office suite application, so as to restrict changes of the whole or the part of the document by reviewers. For another example, an editor of a document created by an office suite application can mark the whole or a part of the document in the application so as to restrict formatting changes (for example, change of font face, change of font size and change of line spacing) of the document by reviewers. When a person opens a formatting-change-restricted document, the person is allowed to edit (change or delete) contents of the document but is not allowed to make a formatting change on a restricted part of the document.

On the other hands, HTML format does not support such restrictions. To create an HTML, document including read-only contents, it is realized by, for example, converting contents of the HTML document into uneditable objects, such as image objects or flash objects, and replacing the original contents in the HTML document with the converted objects. However, in this method, when once the document is converted, the contents of objects in the converted document never become editable and formatting restrictions that allow a reviewer of the document to edit the contents of a formatting-change-restricted part of the document without making formatting changes, are not available.

In view of that, the following document format conversion can be considered. In the conversion of objects in a document created by an office suite application into objects according to HTML format, a text object for which editing restriction is set in the office suite application document (an editing-restricted object) is converted into an image element with an attribute (the alt attribute) the value of which includes the contents of the original text object (text string) so that a person who opens the converted HTML document can edit the text string. However, with the disclosed techniques of the document format conversion, an HTML document in which editing of the contents is restricted as specified in the original office suite application document can be created, but a person who is editing the HTML document is not permitted to add an editing-restricted object into the HTML document so that the editing restrictions work in an office suite application document given by conversion of the HTML document. Further, with the disclosed techniques, a person who is editing the HTML document is not permitted to change editing restrictions that were specified in the original office suite application document so that the changed editing restrictions work in an office suite application document given by conversion of the HTML document.

### SUMMARY

The present invention is directed to document conversion apparatuses, non-transitory computer-readable recording media each storing a document conversion program, and document conversion methods, which can convert a first document created by an office suite application, such as an OOXML document or an ODF document, into a second document in another format supported by web browsers, such as an HTML document, so that the second document maintains one or more editing restrictions specified in the first document and allows a person who opens the second document to edit the document; and can convert the second document that was revised, in the reverse conversion direction so that the office suite application document given by the reverse conversion maintains one or more editing-restricted objects added to the second document and further maintains changes of editing restrictions made in the second document.

A document conversion apparatus reflecting one aspect of the present invention is a document conversion apparatus for converting a document between first format supported by office suite applications and second format supported by web browsers. The document conversion apparatus comprises a hardware processor and a storage unit operatively connected to the hardware processor. The storage unit stores a computer-readable program comprising instructions which, when executed by the hardware processor, cause the hardware processor to perform the following operations. The operations comprise, in response to obtaining a first document in the first format created by an office suite application, analyzing the first document to determine objects according to the first format contained in the first document and to read one or more editing restrictions specified in the first document. The operations further comprise performing first conversion. The first conversion includes converting the objects according to the first format into objects according to the second format, in accordance with the one or more editing restrictions read from the first document. The first conversion further includes creating a second document in the second format, containing the objects according to the second format; adding, to each of the objects contained in the second document, attribute data representing an editing restriction set to a corresponding object according to the first format in the first document, on the basis of the one or more editing restrictions read from the first document; and outputting the second document to an apparatus configured to process a document in the second format. The operations further comprise, in response to obtaining the second document revised by the apparatus, performing second conversion. The second conversion includes analyzing the revised second document to create objects according to the first format from objects contained in the revised second document and to apply either or both of an edit that was made to each of one or more objects in the second document and an edit that was made to the attribute data added to the each of one or more objects in the second document, to a corresponding one of the objects according to the first format created from the revised second document. The second conversion further includes creating a document in the first format, containing the objects according to the first format created from the revised second document.

A non-transitory computer-readable recording medium reflecting one aspect of the present invention stores a document conversion program to be executed in a document conversion apparatus for converting a document between first format supported by office suite applications and second format supported by web browsers. The program comprises instructions which, when executed by the hardware processor of the document conversion apparatus, cause the hardware processor to perform the following operations. The operations comprise, in response to obtaining a first document in the first format created by an office suite application, analyzing the first document to determine objects according to the first format contained in the first document and to read one or more editing restrictions specified in the first document. The operations further comprise performing first conversion. The first conversion includes converting the objects according to the first format into objects according to the second format, in accordance with the one or more editing restrictions read from the first document. The first conversion further includes creating a second document in the second format, containing the objects according to the second format; adding, to each of the objects contained in the second document, attribute data representing an editing restriction set to a corresponding object according to the first format in the first document, on the basis of the one or more editing restrictions read from the first document; and outputting the second document to an apparatus configured to process a document in the second format. The operations further comprise, in response to obtaining the second document revised by the apparatus, performing second conversion. The second conversion includes analyzing the revised second document to create objects according to the first format from objects contained in the revised second document and to apply either or both of an edit that was made to each of one or more objects in the second document and an edit that was made to the attribute data added to the each of one or more objects in the second document, to a corresponding one of the objects according to the first format created from the revised second document. The second conversion further includes creating a document in the first format, containing the objects according to the first format created from the revised second document.

A method reflecting one aspect of the present invention is a document conversion method for use in a system including a document conversion apparatus for converting a document between first format supported by office suite applications and second format supported by web browsers. The method comprises, in response to obtaining a first document in the first format created by an office suite application, analyzing the first document by a hardware processor of the document conversion apparatus, to determine objects according to the first format contained in the first document and to read one or more editing restrictions specified in the first document. The method farther comprises performing first conversion by the hardware processor of the document conversion apparatus. The first conversion includes converting the objects according to the first format into objects according to the second format, in accordance with the one or more editing restrictions read from the first document. The first conversion further includes creating a second document in the second format, containing the objects according to the second format; and adding, to each of the objects contained in the second document, attribute data representing an editing restriction set to a corresponding object according to the first format in the first document, on the basis of the one or more editing restrictions read from the first document. The method further comprises outputting, by the hardware processor of the document conversion apparatus, the second document to an apparatus configured to process a document in the second format; and in response to obtaining the second document revised by the apparatus, performing second conversion by the hardware processor of the document conversion apparatus. The second conversion includes analyzing the revised second document to create objects according to the first format from objects contained in the revised second document and to apply either or both of an edit that was made to each of one or more objects in the second document and an edit that was made to the attribute data added to the each of one or more objects in the second document, to a corresponding one of the objects according to the first format created from the revised second document. The second conversion further includes creating a document in the first format, containing the objects according to the first format created from the revised second document.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic diagram illustrating an example of the constitution of a system according to one embodiment of the present invention;

FIGS. 2A and 2B are block diagrams illustrating an example of the constitution of a document conversion apparatus in the system according to one embodiment of the present invention;

FIGS. 3A and 3B are block diagrams illustrating an example of the constitution of a web browsing apparatus in the system according to one embodiment of the present invention;

FIG. 4 is a flowchart illustrating an example of operations of the system according to one embodiment of the present invention;

FIG. 5 is a flowchart illustrating an example of operations (OOXML to HTML conversion) of the document conversion apparatus according to one embodiment of the present invention;

FIG. 6 is a diagram illustrating an example of a screen (object-conversion-mode selection screen) to be displayed by the document conversion apparatus according to one embodiment of the present invention;

FIG. 7 is a flowchart illustrating an example of operations (applying editing restrictions in the OOXML to HTML conversion) of the document conversion apparatus according to one embodiment of the present invention;

FIG. 8 is a flowchart illustrating an example of operations (processing an HTML document) of the web browsing apparatus according to one embodiment of the present invention;

FIG. 9 is a flowchart illustrating an example of operations (HTML to OOXML conversion) of the document conversion apparatus according to one embodiment of the present invention;

FIG. 10 is a flowchart illustrating an example of operations (applying editing restrictions in the HTML to OOXML conversion) of the document conversion apparatus according to one embodiment of the present invention;

FIG. 11 is a diagram illustrating an example of a screen (restriction-applying-mode selection screen) to be displayed by the document conversion apparatus according to one embodiment of the present invention;

FIG. 12 is a diagram illustrating an example of a folder structure of an OOXML document file;

FIG. 13 is a diagram illustrating an example of a part of an editing-restricted OOXML document in which no changes are allowed;

FIGS. 14A and 14B are diagrams illustrating an example of a part of an editing-restricted OOXML document in which formatting changes are restricted; and

FIGS. 15A to 15D are diagrams illustrating an example of OOXML to HTML conversion according to one embodiment of the present invention.

### DETAILED DESCRIPTION OF EMBODIMENTS

Hereinafter, one or more embodiments of the present invention will be described with reference to the drawings. However, the scope of the invention is not limited to the illustrated embodiments.

As for a use of documents in the office suite application format, there are demands for a technique to convert documents created by office suite applications into another document format supported by standard web browsers, such as HTML format, for example, so that persons using a mobile terminal can read documents created by the office suite applications on their mobile terminal. There are demands for another technique to convert documents created by office suite applications into HTML format or save the documents as HTML documents so as to allow users of office suite applications to create a draft of web pages.

Office suite applications are configured to allow a person who is editing a document, to specify various restrictions on the document so as to prevent reviewers of the document from changing the document. For example, when an editor of a document created by an office suite application distributes the document for other persons and does not want them to change the whole or a part of the document, the editor can mark the whole or the part of the document as read-only in the office suite application, so as to restrict changes of the whole or the part of the document by reviewers. For another example, an editor of a document created by an office suite application can mark the whole or a part of the document in the application, so as to restrict formatting changes (for example, change of font face, change of font size and change of line spacing) of the document by reviewers and allow the reviewers to edit (change or delete) contents of the document.

On the other hands, HTML format does not support such restrictions. To create an HTML document including read-only contents, it is realized by, for example, converting contents of the HTML document into uneditable objects, such as image objects or flash objects, and replacing the original contents in the HTML document with the converted objects. However, in this method, when once the document is converted, the contents of objects in the converted document never become editable and formatting restrictions that allow a reviewer of the document to edit the contents of a formatting-change-restricted part of the document without making formatting changes, are not available.

In view of that, the following document format conversion can be considered. In the conversion of objects in a document created by an office suite application into objects according to HTML format, a text object for which editing restriction is set in the office suite application document (an editing-restricted object) is converted into an image element with an attribute (the alt attribute) the value of which includes the contents of the original text object (text string) so that a person who opens the converted HTML document can edit the text string. However, with the disclosed techniques of the document format conversion, an HTML document in which editing of the contents is restricted as specified in the original office suite application document can be created but a person who is editing the HTML document is not permitted to add an editing-restricted object into the HTML document so that the editing restrictions work in an office suite application document given by conversion of the HTML document. Further, with the disclosed techniques, a person who is editing the HTML document is not permitted to change editing restrictions that were specified in the original office suite application document so that the changed editing restrictions work in an office suite application document given by conversion of the HTML document.

In view of that, the following operations of a document conversion apparatus are provided as an embodiment of the present invention. The document conversion apparatus is configured to convert a document in first format, such as OOXML, format or ODF format, created by an office suite application (referred to as an office document), into a document in second format, such as HTML format, supported by web browsers (referred to as an HTML document) and convert a document in second format in the reverse conversion direction. A hardware processor of the document conversion apparatus performs, when executing a document conversion program, the following operations. The hardware processor obtains an office document and analyzes the office document to determine objects according to the first format (referred to as OOXML objects) contained in the office document and to read one or more editing restrictions specified in the office document. The hardware processor then converts the OOXML objects to HTML format, in accordance with the one or more editing restrictions read from the office document, and creates an HTML document containing the converted objects (first conversion). The hardware processor then outputs the created HTML document to an apparatus configured to process a document in HTML format. In response to obtaining the HTML document revised by the apparatus, the hardware processor of the document conversion apparatus analyzes the revised HTML document to create OOXML objects (in other words, reproduce OOXML objects) from objects contained in the revised HTML document. The hardware processor then performs second conversion by converting the revised HTML document into an office document on the basis of the OOXML objects created from the revised HTML document (in other words, creating an office document containing the OOXML objects created from the revised HTML document). In the first conversion, the hardware processor adds, to each object in the HTML document, attribute data based on of the one or more editing restrictions read from the office document, where the attribute data may include an attribute (for example, a class attribute) and its value which represents an editing restriction set to an OOXML object in the office document corresponding to the each object in the HTML document, and if needed, further include another attribute (for example, an id attribute) and its value which represent information identifying an OOXML object in the office document corresponding to the each object in the HTML document. In the second conversion, the hardware processor applies either or both of an edit that was made to each of one or more objects in the HTML document and an edit that was made to the attribute data added to the each of one or more objects in the HTML document, to a corresponding one of the OOXML objects created from the revised HTML document.

By adding the attribute data to each object in the HTML document, the correlation between an object in the office document and an object in the HTML document can be made by using the id attribute and the correlation between editing restrictions in the office document and those in the HTML document can be made by using the class attribute. When a person opens the HTML document converted from the office document and adds a new object into the HTML document, the person can set an editing restriction to the new object by adding a description about the editing restriction into the value of the class attribute of the new object. When a person opens the HTML document converted from the office document and changes an editing restriction set to an object in the HTML document, the person can also change the editing restriction by changing the value of the class attribute of the object.

On judging that one or more editing restrictions are specified in the office document in the first conversion, the hardware processor may convert one or more editing-restricted OOXML, objects in the office document, into one or more image objects, by making an image form an appearance of each of the one or more editing-restricted OOXML objects, and convert the other OOXML, objects into corresponding objects according to HTML format. On creating OOXML objects from the objects contained in the revised HTML document in the second conversion, the hardware processor may create one or more editing-restricted OOXML objects in accordance with an existence of an image object corresponding to each of the OOXML objects and an existence of a change of the attribute data of the image object. In the second conversion, the hardware processor may compare a first editing restriction set to each of OOXML objects contained in the office document with a second editing restriction indicated by the attribute data added to an object according to HTML format in the revised HTML document, corresponding to the each of the OOXML objects contained in the office document, and apply the second editing restriction to each of the OOXML, objects created from the revised HTML document on condition that the second editing restriction is stricter than the first editing restriction.

The above-described operations allow the conversion of a document created by an office suite application (an office document) into a second document in another format supported by web browsers (an HTML document) so that the HTML document maintains editing restrictions specified in the office document and allows a person who opens the HTML document to edit the HTML document. The above-described operations further allow the conversion of the HTML document that was revised, into the reverse conversion direction so that the office document given by the reverse conversion maintains editing-restricted objects added to the HTML document and changes of editing restrictions made in the HTML document.

### Embodiment

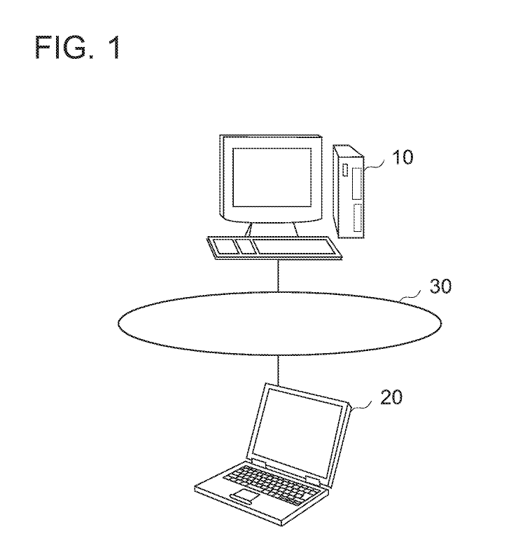

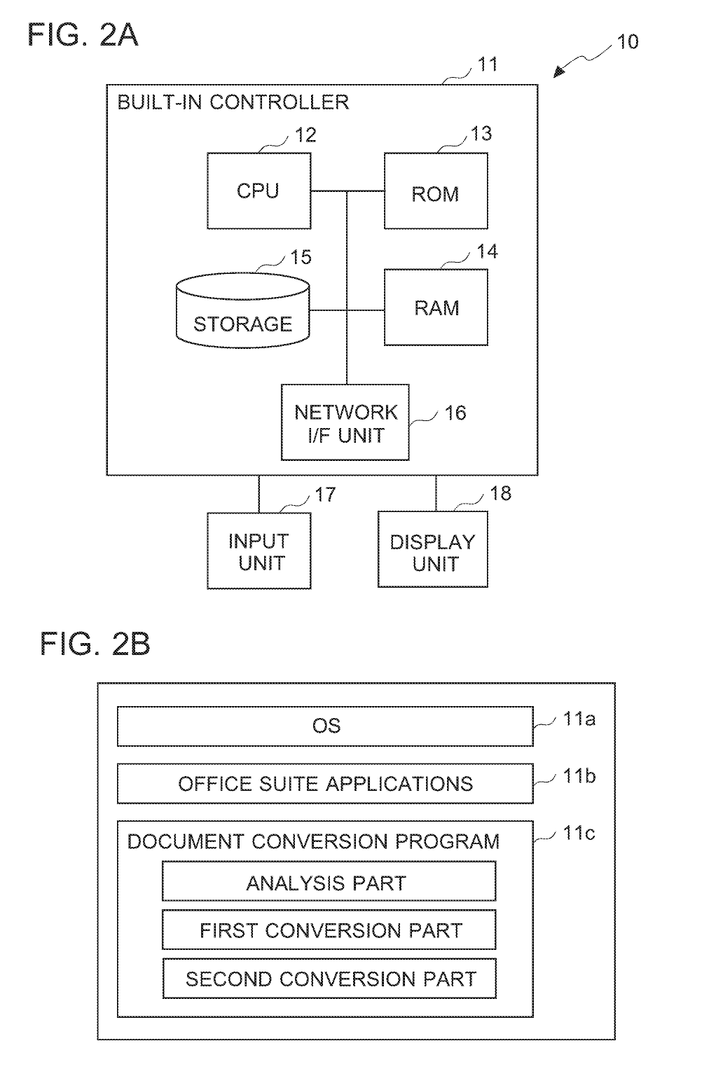

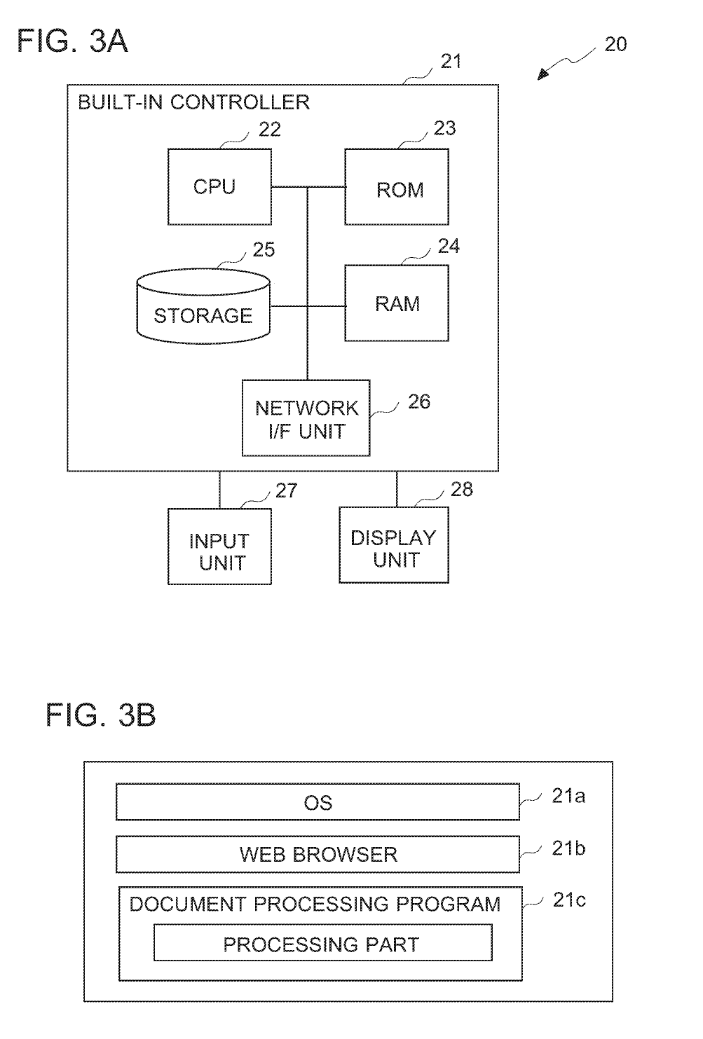

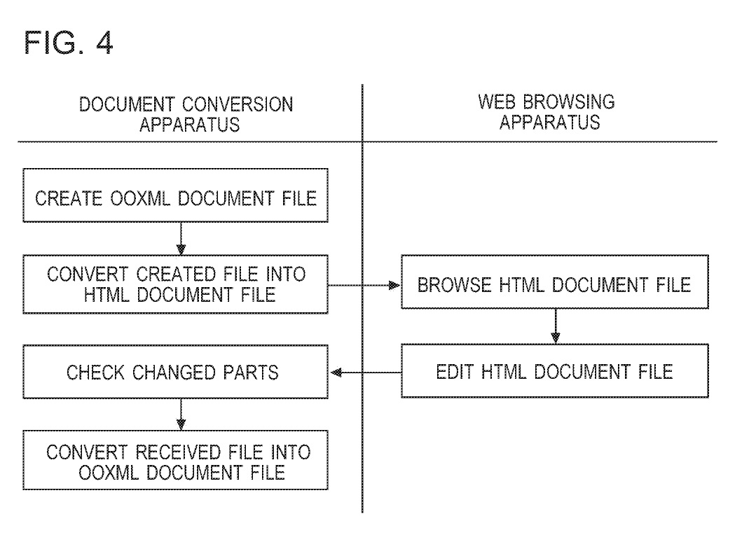

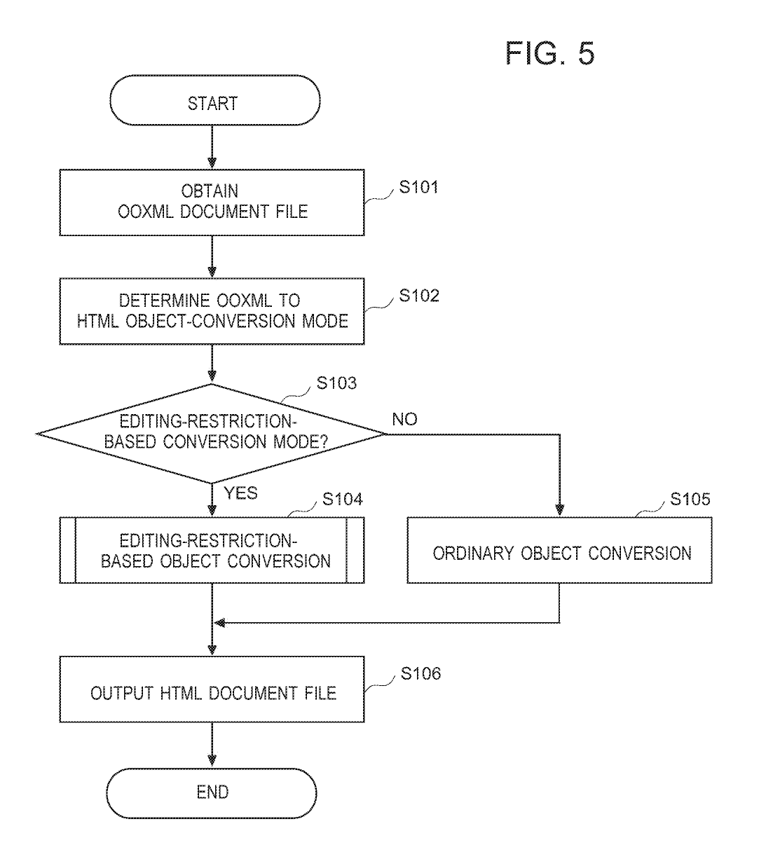

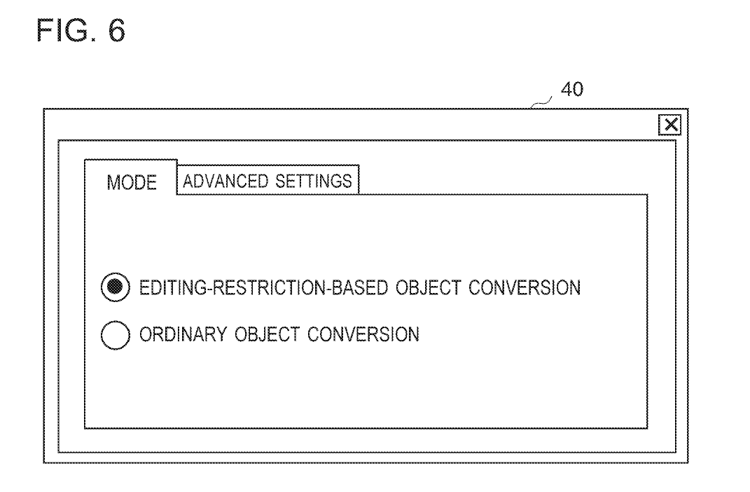

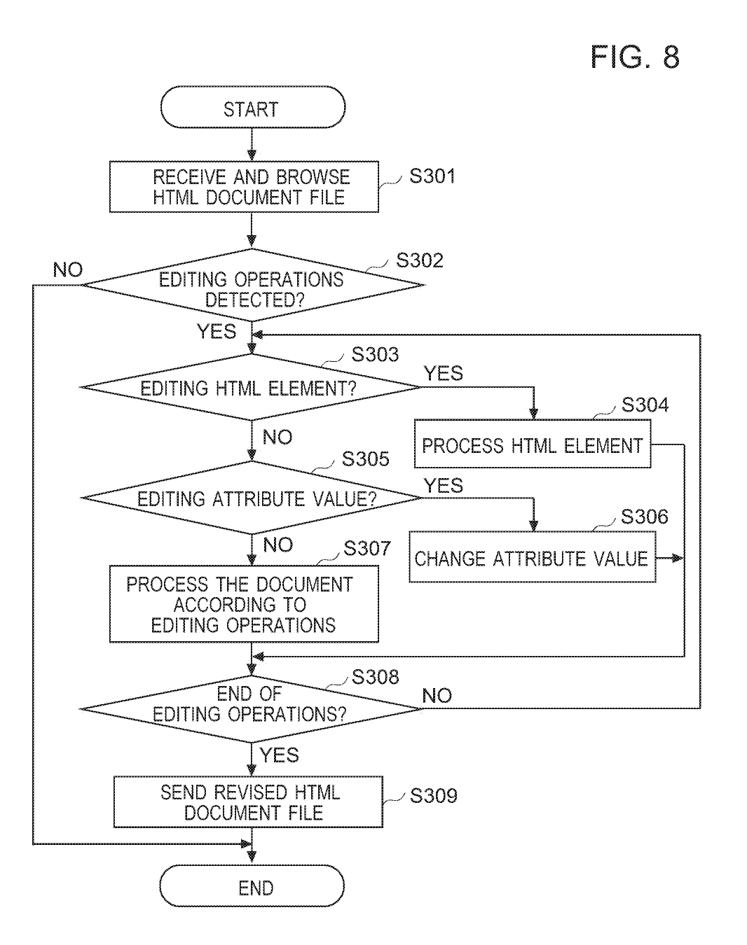

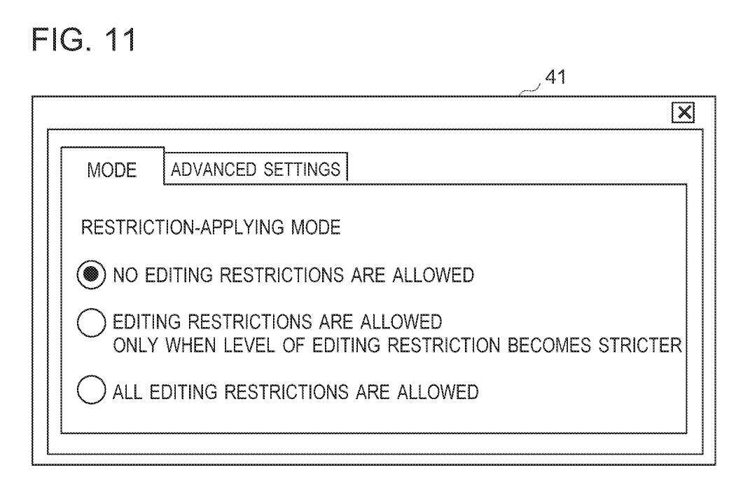

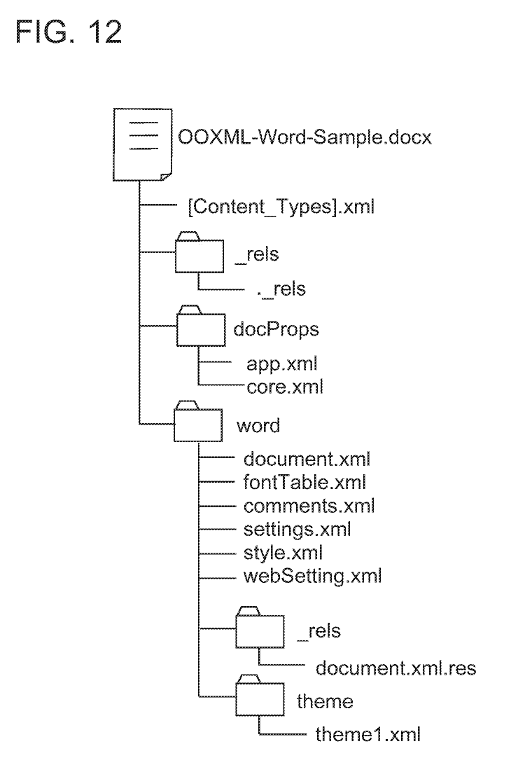

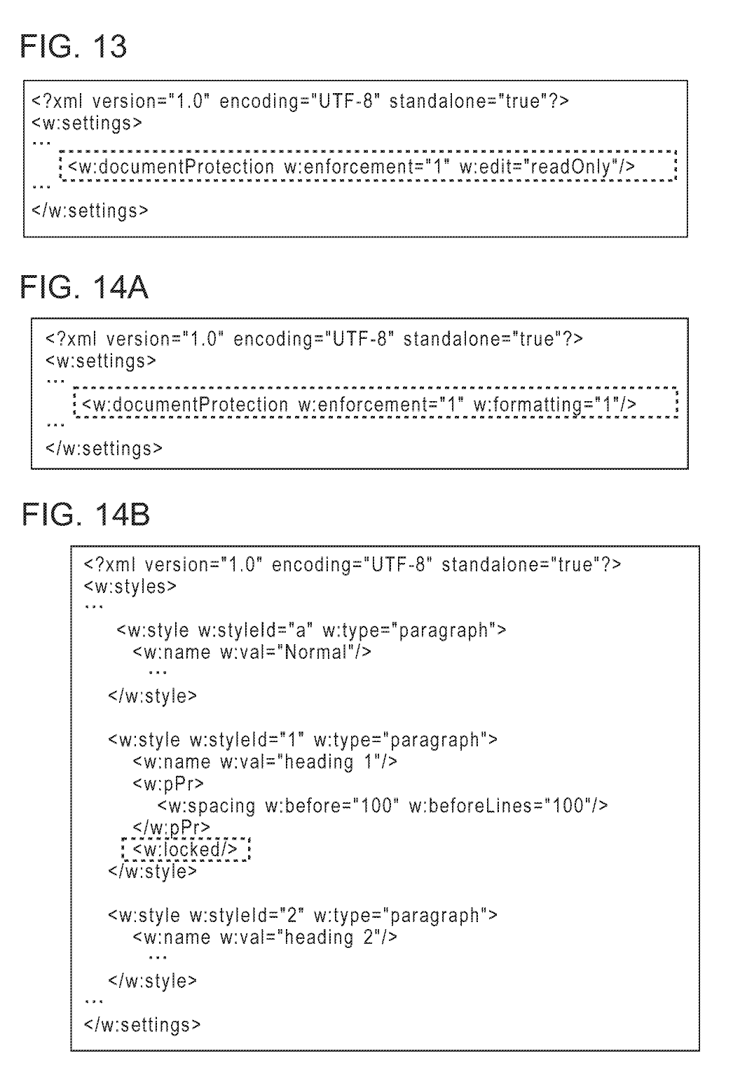

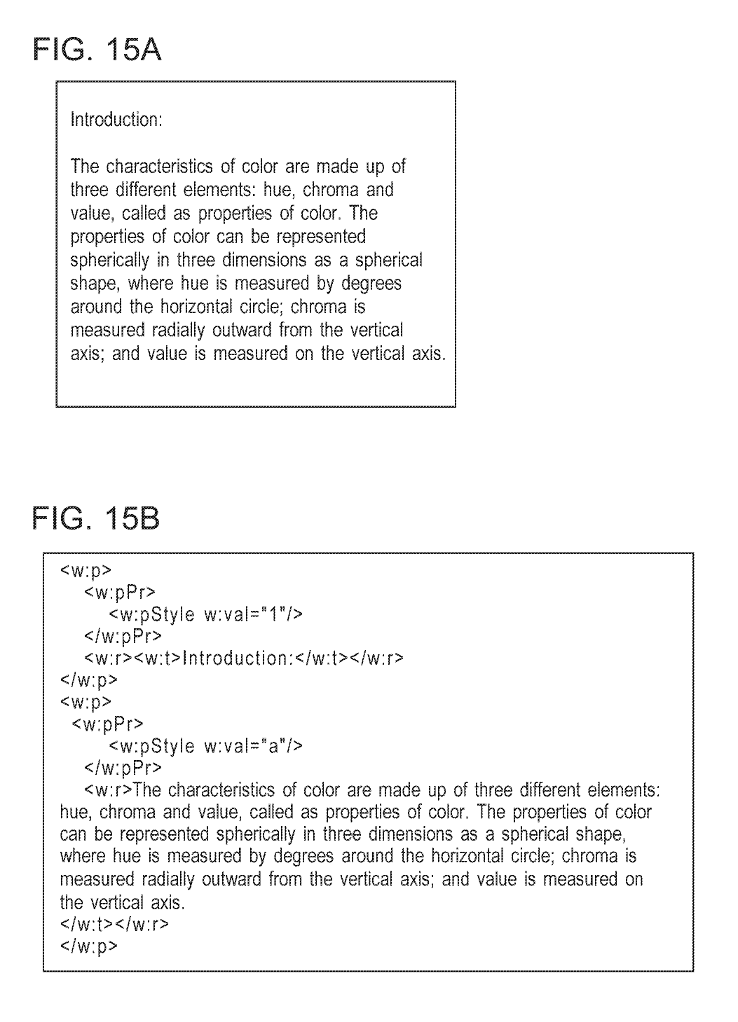

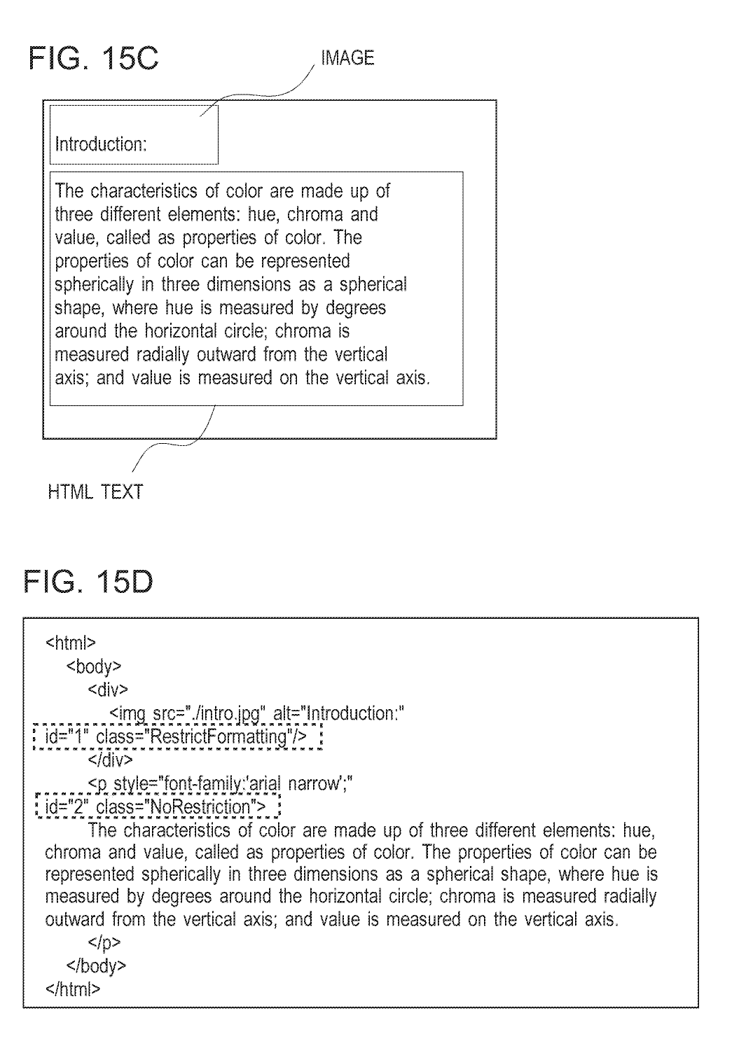

In order to describe an embodiment of the present invention in more in detail, a description is given of a document conversion apparatus, a non-transitory computer-readable recording medium storing a document conversion program, and document conversion method, with reference to FIG. 1 through FIG. 15D, FIG. 1 is a schematic diagram illustrating an example of the constitution of a system according to the present embodiment. FIGS. 2A and 2B are block diagrams illustrating an example of the constitution of a document conversion apparatus in the system according to the present embodiment. FIGS. 3A and 3B are block diagrams illustrating an example of the constitution of a web browsing apparatus in the system according to the present embodiment, FIG. 4 is a flowchart illustrating an example of operations of the system according to the present embodiment. Each of FIGS. 5, 7, 9 and 10 is a flowchart illustrating an example of operations of the document conversion apparatus. FIG. 8 is a flowchart illustrating an example of operations of the web browsing apparatus. Each of FIGS. 6 and 11 is a diagram illustrating an example of a screen to be displayed by the document conversion apparatus. FIG. 12 is a diagram illustrating an example of a folder structure of an OOXML document file. FIG. 13 and FIGS. 14A and 14B are diagrams illustrating examples of a part of an editing-restricted OOXML document. FIGS. 15A to 15D are diagrams illustrating an example of OOXML to HTML conversion.

As illustrated in FIG. 1, the system according to the present embodiment includes document conversion apparatus 10 and web browsing apparatus 20. Document conversion apparatus 10 is configured to analyze an office document created by an office suite application, such as an OOXML document or an ODF document, convert the office document into a document in another format supported by web browsers, such as an HTML document, and convert the HTML document that was revised, in the reverse conversion direction, to create a revised office document. Web browsing apparatus 20 is configured to browse and edit an HTML document converted from an office document by document conversion apparatus 10. These apparatuses are communicatively connected to each other via communication network 30, where examples of the communication network 30 include a LAN (Local Area Network) and WAN (Wide Area Network) defined by specifications, such as Ethernet, Token Ring and FDDI (Fiber-Distributed Data Interface). Hereinafter, a detailed description is given of each of the apparatuses.

### Document Conversion Apparatus

Document conversion apparatus 10 is a computing device, where examples of document conversion apparatus 10 include personal computers, mobile terminals including smartphones and tablets, and severs placed in communication network 30. Document conversion apparatus 10 includes, as illustrated in FIG. 2A, built-in controller 11, network interface (I/F) unit 16, input unit 17 and display unit 18.

Built-in controller 11 includes CPU (Central Processing Unit) 12 as a hardware processor, memories including ROM (Read Only Memory) 13 and RAM (Random Access Memory) 14, and storage unit 15 (a non-transitory computer-readable recording medium) including a HDD (Hard Disk Drive) and/or a SSD (Solid State Drive). CPU 12 reads out control programs stored in ROM 13 or storage unit 15, loads the control programs onto RAM 14, and executes the control programs, thereby controlling operations of the components of document conversion apparatus 10.

As illustrated in FIG. 2B, built-in controller 11 is configured to execute OS (Operating System) 11a, office suite applications 11b and document conversion program 11c.

Examples of OS 11a include Microsoft Windows, macOS and Android, where Microsoft and Windows are either registered trademarks or trademarks of Microsoft Corporation in the United States and/or other countries, macOS is a registered trademark or trademark of Apple Inc. in the United States and/or other countries, and Android is a registered trademark or trademark of Google Inc. in the United States and/or other countries. OS 11a manages application programs including office suite applications 11b and document conversion program 11c in document conversion apparatus 10 so as to function and run the application programs.

Office suite applications 11b are software programs including, for example, a word processor, a spreadsheet, and an image or photo editor, and allow a user to create office documents, such as OOXML documents and ODF documents. In the present embodiment, a description is given by using Microsoft Word as one instance of office suite applications 11b.

Document conversion program 11c causes, when being executed by CPU 12, document conversion apparatus 10 (built-in controller 11) to convert a document between office suite application format (such as OOXML or ODF format) and HTML format. The document conversion program 11c includes an analysis part, a first conversion part and a second conversion part.

The analysis part causes, when being executed by CPU 12, document conversion apparatus 10 (built-in controller 11) to perform the following processing. In response to obtaining an office document which is a document in OOXML or ODF format (first format), built-in controller 11 analyzes the office document to determine objects represented by specific descriptions according to the first format (OOXML objects), contained in the office document. Built-in controller 11 checks data files forming the office document and descriptions in the data files and reads one or more editing restrictions specified in the office document.

The first conversion part causes, when being executed by CPU 12, built-in controller 11 to perform the following processing. Built-in controller 11 causes display unit 18 to display an object-conversion-mode selection screen which prompts an operator to select an object-conversion mode to be used in the conversion of an office document to HTML format (second format), where the screen allows an operator to select one of first conversion mode (editing-restriction-based object-conversion mode) in which OOXML objects in an office document are converted into objects according to HTML format (HTML elements) while applying one or more editing restrictions specified in the office document to the HTML elements, and second conversion mode (ordinary object-conversion mode) in which OOXML objects in an office document are converted into objects according to HTML format (HTML elements) regardless of one or more editing restrictions specified in the office document. Built-in controller 11 then changes the object-conversion mode according to operator's selection of the object-conversion mode made through input unit 17, and converts OOXML objects in the office document according to the selected object-conversion mode, to create an HTML document containing the converted objects. Built-in controller 11 outputs and sends the created HTML document to web browsing apparatus 20.

In concrete terms, under the condition that the ordinary object-conversion mode has been selected, built-in controller 11 converts all the OOXML objects contained in the office document into corresponding objects according to the second format (hereinafter, referred to as HTML elements or elements) regardless of the existence of editing restrictions specified in the office document. Under the condition that the editing-restriction-based object-conversion mode has been selected, built-in controller 11 converts, if no editing restriction is specified in the office document, all the OOXML objects in the office document into corresponding HTML elements, and converts, if one or more editing restrictions are specified in the office document, one or more OOXML objects for each of which an editing restriction is set (one or more editing-restricted OOXML objects) into one or more image elements and the other OOXML objects (OOXML objects for which no editing restriction is set) into corresponding HTML elements, where each image elements is prepared by making an image from the appearance of the editing-restricted OOXML object in accordance with the one or more editing restrictions and by creating an image element specifying the location of the image.

In the object conversion, when finding a text object in the editing-restricted OOXML objects, built-in controller 11 adds the contents of the text object (text string) to the image element converted from the text object, in a manner that a person who opens the converted HTML document by a web browser views the image created from the text object in place of the text string (the contents of the text object) but the text string is editable as data embedded in the converted HTML document file. That is, built-in controller 11 inserts the text string into the value of the alt attribute of the image element, where the alt attribute is an attribute of an image element according to HTML format to provide alternative text information for an image if a user for some reason cannot view it on a web browser. In the present embodiment, built-in controller 11 converts one or more editing-restricted OOXML objects in the office document into one or more images elements, by making an image from the appearance of each of the OOXML objects in accordance with the one or more editing restrictions to create an image element and by inserting the text information into the alt attribute value of the image element corresponding to each of the OOXML objects. These operations may be performed also on the other OOXML objects (OOXML objects for which no editing restriction is set) in the office document.

The first conversion part further causes, when being executed, built-in controller to perform the following processing. To each object in the HTML document (image elements created from editing-restricted OOXML objects, and other HTML elements), built-in controller 11 adds a common attribute (a class attribute) the value of which represents an editing restriction set to the corresponding OOXML object in the office document, and if needed, another common attribute (an id attribute) the value of which represents information identifying the corresponding OOXML object. That is, the correlation between an OOXML object and an image element or an HTML element is made by using the id attribute and the correlation between editing restrictions in an office document and those in an HTML document is made by using the class attribute.

The second conversion part causes, when being executed by CPU 12, built-in controller 11 to perform the following processing. In response to receiving, from web browsing apparatus 20, the HTML document in which either or both of one or more objects and attribute data were changed by a user of web browsing apparatus 20, built-in controller 11 analyzes the received HTML document, creates OOXML objects on the basis of image elements and the other HTML elements contained in the HTML document, and converts the HTML document into an office document containing the created OOXML objects. In this process, built-in controller 11 applies either or both of an edit that was made to each object in the HTML document and an edit that was made to the attribute data (the class attribute value) added to the each object, to a corresponding OOXML object (OOXML objects correlated with the each object in the HTML document by using the id attribute).

For example, on creating OOXML objects from objects contained in the received HTML document in the second conversion, built-in controller 11 checks the existence of an image element in the received HTML document, corresponding to each of the OOXML objects, and an existence of a change of the attribute data (the class attribute value) of the image element, and creates one or more editing-restricted objects in accordance with these existences. Built-in controller 11 further compares the editing restriction set to each original OOXML object in the office document with the editing restriction indicated by the attribute data (the class attribute value) added to the corresponding image element or the corresponding HTML element. Built-in controller 11 applies the editing restriction indicated by the attribute data (the class attribute value) to an OOXML object created from the received HTML document on condition that the editing restriction indicated by the attribute data (the class attribute value) is stricter than the editing restriction set to the original OOXML object.

The second conversion part further causes, when being executed by CPU 12, built-in controller 11 to perform the following processing. Built-in controller 11 causes display unit 18 to display a screen which prompts an operator to select a restriction-applying mode, where the screen allows an operator to select one of first mode in which an editing restriction indicated by the attribute data of each object in the received HTML document is allowed to be applied to a corresponding OOXML object; second mode in which an editing restriction indicated by the attribute data of each object in the received HTML document is allowed to be applied to a corresponding OOXML object on condition that application of the editing restriction indicated by the attribute data increases the level of the editing restriction set to the corresponding OOXML object; and third mode in which an editing restriction indicated by the attribute data of each object in the received HTML document is not allowed to be applied to a corresponding OOXML object. In response to an operator's selection of the second mode through input unit 17, built-in controller 11 makes the above-described comparison of the levels of editing restriction and applies the editing restriction to each OOXML object created from the received HTML document, according to the comparison result. Built-in controller 11 prompts users of document conversion apparatus 10 to input a user ID and a password, to perform user authentication, and in response to judging that a person who converted an office document into an HTML document agrees with a person who is converting the received HTML document in the reverse conversion direction, automatically selects the first restriction-applying mode in which an editing restriction indicated by the attribute data (the class attribute value) of each object in the received HTML document is allowed to be applied to a corresponding OOXML object, without prompting an operator to select the restriction-applying mode.

Network I/F unit 16 includes a NIC (Network Interface Card) and/or a modem. Network I/F unit 16 communicatively connects document conversion apparatus 10 to communication network 30 so as to conduct data communications with web browsing apparatus 20.

Input unit 17 includes input devices, such as a mouse, a keyboard and a touch screen, and allows an operator to perform operations to create or edit a document by using one of office suite applications 11b, select the object conversion mode, and select the restriction-applying mode.

Display unit 18 includes a display like a LCD (liquid crystal display) or an OEL (organic electroluminescence) display, so as to display various screens including document processing screens of office suite applications 11b, the object-conversion-mode selection screen, and the restriction-applying-mode selection screen.

### Web Browsing Apparatus

Web browsing apparatus 20 is a computing device, where examples of web browsing apparatus 20 include personal computers and mobile terminals including smartphones and tablets. Web browsing apparatus 20 includes, as illustrated in FIG. 3A, built-in controller 21, network interface (I/F) unit 26, input unit 27 and display unit 28.

Built-in controller 21 includes CPU (Central Processing Unit) 22 as a hardware processor, memories including ROM (Read Only Memory) 23 and RAM (Random Access Memory) 24, and storage unit 25 (a non-transitory computer-readable recording medium) including a HDD and/or a SSD. CPU 22 reads out control programs stored in ROM 23 or storage unit 25, loads the control programs onto RAM 24, and executes the control programs, thereby controlling operations of the components of web browsing apparatus 20.

As illustrated in FIG. 3B, built-in controller 21 is configured to execute OS (Operating System) 21a, web browser 21b and document processing program 21c.

Examples of OS 21a include Microsoft Windows, macOS and Android, OS 21a manages application programs including web browser 21b and document processing program 21c in web browsing apparatus 20 so as to function and run the application programs.

Examples of web browser 21b include Internet Explorer, Microsoft Edge, Safari, Firefox, Google Chrome and Opera, where Internet Explorer and Microsoft Edge are either registered trademarks or trademarks of Microsoft Corporation in the United States and/or other countries, Safari is a registered trademark or trademark of Apple Inc. in the United States and/or other countries, Firefox is a registered trademark or trademark of Mozilla Foundation in the United States and/or other countries, Google Chrome is a registered trademark or trademark of Google Inc. in the United States and/or other countries, and Opera is a registered trademark or trademark of Opera. Software in the United States and/or other countries. Web browser 21b causes, when being executed by CPU 22, display unit 28 to display an HTML document received from document conversion apparatus 10.

Document processing program 21c causes, when being executed by CPU 22, web browsing apparatus 20 (built-in controller 21) to process an HTML document. The document processing program 21c includes a processing part.

The processing part causes, when being executed by CPU 22, web browsing apparatus 20 (built-in controller 21) to perform the following processing. Built-in controller 21 monitors operator's operations to edit objects in an HTML document (image elements and other HTML elements). In response to detecting operator's operations to edit an HTML element other than image elements in the HTML document, built-in controller 21 processes the contents of the element according to the operator's operations. In response to detecting operator's operations to edit an image element in the HTML document, built-in controller 21 processes the alt attribute value of the image element according to the operator's operations. In response to detecting operator's operations to add a new object into the HTML document, built-in controller 21 prompts the operator to input the editing restriction to be set to the object and sets the editing restriction into the class attribute value of an HTML element created from the new object. In response to detecting operator's operations to change the editing restriction set to an object in the HTML document, built-in controller 21 similarly prompts the operator to input an editing restriction to be set to the object and changes the editing restriction set in the class attribute value of the HTML element corresponding to the object.

Network I/F unit 26 includes a NIC and/or a modem. Network I/F unit 26 communicatively connects web browsing apparatus 20 to communication network 30 so as to conduct data communications with document conversion apparatus 10.

Input unit 27 includes input devices, such as a mouse, a keyboard and a touch screen, which allows an operator to perform operations to edit an HTML document displayed on display unit 28 by web browser 21b (including operations to edit alt attribute values and operations to specify class attribute values).

Display unit 28 includes a display like a LCD or an OEL display, so as to display various screens including screens of web browser 21b.

It should be noted that FIG. 1 to FIG. 3B illustrate an example of the system according to the present embodiment for illustrative purpose only, and the constitution and operations of each apparatus in the system may be modified appropriately, as far as the operations given in the present embodiment can be achieved. For example, through the system illustrated in FIG. 1 employs a computing device as an instance of document conversion apparatus 10, an image forming apparatus such as a MFP (Multi-Functional Peripheral) may be employed as another instance of document conversion apparatus 10. As another example, though document conversion apparatus 10 in FIG. 1 is configured to create office documents, document conversion apparatus 10 may be configured to receive office documents, such as OOXML documents and ODF documents, created by other computing devices connected to document conversion apparatus 10 through communication network 30, and to convert the received office documents into HTML documents; or document conversion apparatus 10 may be configured to serve as an apparatus for processing HTML documents. That is, document conversion apparatus 10 according to the present embodiment may have an arbitrary construction as far as at least the instructions of the document conversion program according to the present embodiment can be executed in the apparatus.

### Outline Operations Of Document Conversion

Hereinafter, a description is given of the operations of the system according to the present embodiment, with reference to drawings. First, a description is given of the outline operations of the system, with reference to the flowchart of FIG. 4. It is assumed that an OOXML document is used as an example of an office document.

Document conversion apparatus 10 (built-in controller 11) creates an OOXML document file by executing one of office suite applications 11b, and converts the OOXML document file into an HTML document file by executing document conversion program 11c (first conversion part), to send the HTML document file to web browsing apparatus 20. Performing this conversion under the condition that the editing-restriction-based object-conversion mode has been selected on the object-conversion-mode selection screen, which will be described later, document conversion apparatus 10 (built-in controller 11) converts one or more editing-restricted OOXML objects in the OOXML document into one or more image elements, by making an image form the appearance of each of the one or more editing-restricted OOXML objects. On finding a text object in the one or more editing-restricted OOXML objects in this process, document conversion apparatus 10 (built-in controller 11) adds the contents of the text object (text string) to the value of an attribute (the alt attribute) of the image element. Document conversion apparatus 10 (built-in controller 11) further converts the other OOXML objects (for which editing restrictions are not set) into corresponding HTML elements. Document conversion apparatus 10 (built-in controller 11) adds attribute data including the id attribute and the class attribute to each of the converted elements so as to correlate each OOXML object with the corresponding element by using the id attribute and correlate editing restrictions between the OOXML document and the corresponding HTML document by using the class attribute.

In response to receiving the HTML document file from document conversion apparatus 10, web browsing apparatus 20 (built-in controller 21) causes display unit 28 to display the HTML document so as to allow an operator to browse and edit the HTML document. On receiving operator's operations to edit the HTML document through input unit 27, web browsing apparatus 20 (built-in controller 21) processes the HTML document file according to the operator's operations and creates a revised HTML document, by executing document processing program 21c (processing part), to send the revised HTML document file to document conversion apparatus 10. In the document processing, on receiving operator's operations to edit an image element converted from an editing-restricted OOXML object, web browsing apparatus 20 (built-in controller 21) processes the attribute value (the alt attribute value) of the image element according to the operator's operations; and on receiving operator's operations to edit an HTML element (other than image elements converted from editing-restricted OOXML objects), web browsing apparatus 20 (built-in controller 21) processes the HTML element according to the operator's operations. On receiving operator's operations to add a new object into the document, web browsing apparatus 20 (built-in controller 21) sets an editing restriction to the object, by specifying the value of the class attribute of the corresponding HTML element; and on receiving operator's operations to change an editing restriction set to the object in the HTML document, web browsing apparatus 20 (built-in controller 21) changes the editing restriction, by changing the value of the class attribute of the corresponding HTML element.

In response to receiving the revised HTML document file from web browsing apparatus 20, document conversion apparatus 10 (built-in controller 11), by executing document conversion program 11c (second conversion part), analyzes the received HTML document file to read elements in the received HTML document, and converts the received HTML document file to the OOXML format by creating OOXML objects from the elements read from the received HTML document file. In the conversion of the received HTML document, document conversion apparatus 10 (built-in controller 11) identifies each of the OOXML objects on the basis of the id attribute value of the corresponding image element or element in the received HTML document, and applies, to each of the identified OOXML objects, an edit that was made to the corresponding element in the received HTML document (for example, changes the contents of the OOXML object according to the alt attribute value of the corresponding element in the received HTML document) and an edit that was made to the class attribute value added to the corresponding element (if the edit exists).

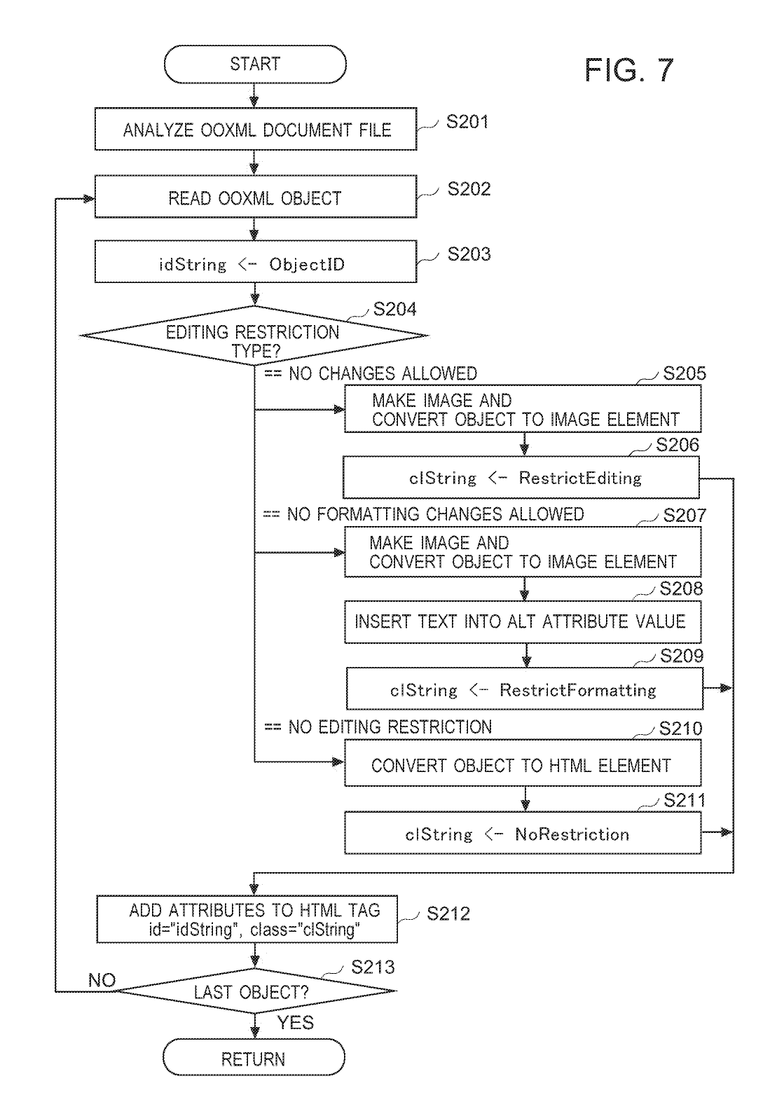

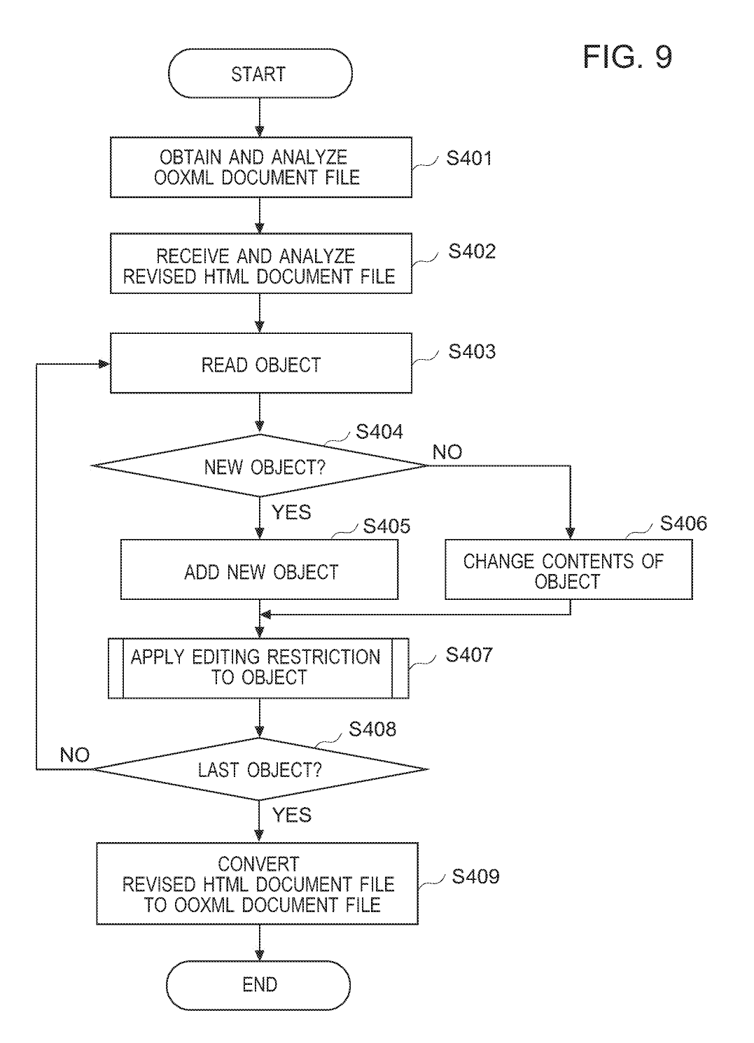

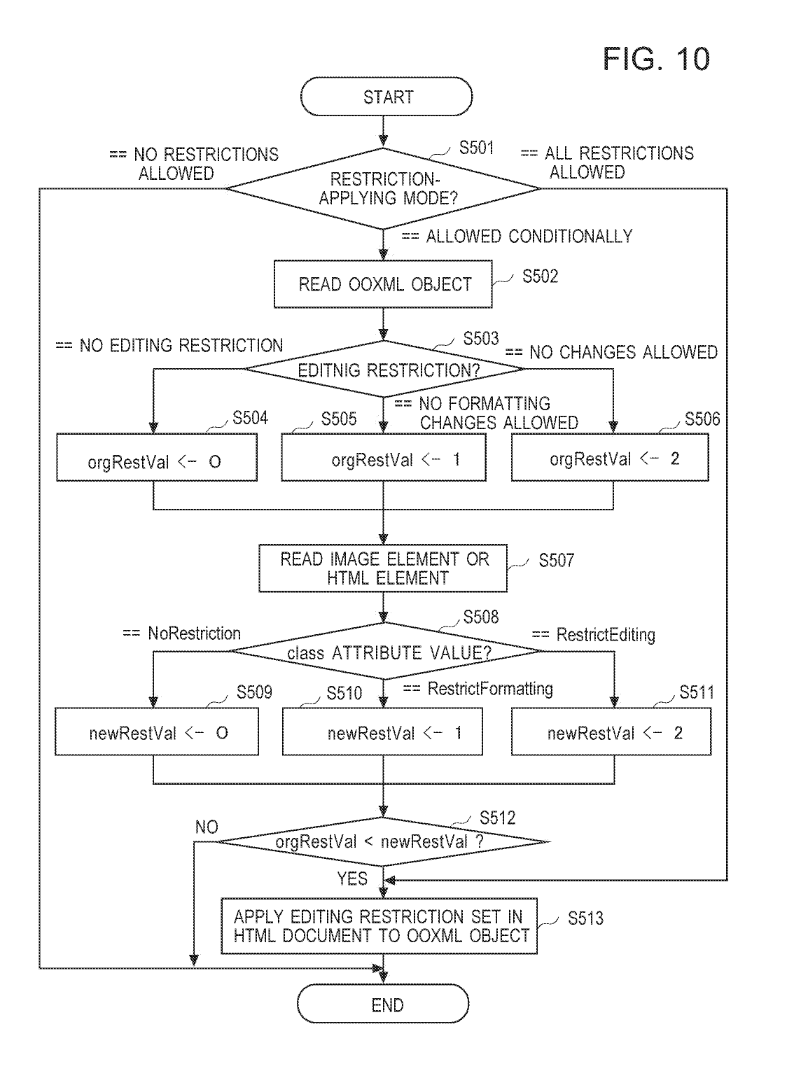

Hereinafter, descriptions are given of OOXML to HTML conversion (first conversion) to be executed by document conversion apparatus 10, document processing of an HTML document to be executed by web browsing apparatus 20 and HTML to OOXML conversion (second conversion) to be executed by document conversion apparatus 10. Built-in controller 11 (CPU 12) of document conversion apparatus 10 reads out the document conversion program stored in ROM 13 or storage unit 15, loads the program onto RAM 14, and executes the program, thereby executing the steps of the flowcharts illustrated in FIGS. 5, 7, 9 and 10, where the flowcharts of FIGS. 5 and 7 represent the OOXML to HTML conversion and the flowcharts of FIGS. 9 and 10 represent the HTML to OOXML conversion. Built-in controller 21 (CPU 22) of web browsing apparatus 20 reads out the document processing program stored in ROM 23 or storage unit 25, loads the program onto RAM 24, and executes the program, thereby executing the steps of the flowcharts illustrated in FIG. 8, which represents the processing of an HTML document.

### OOXML to HTML Conversion

As illustrated in FIG. 5, document conversion program 11c (analysis part) causes built-in controller 11 to obtain an OOXML document file created by one of office suite applications 11b in document conversion apparatus 10 or an OOXML document file given from an external computing device (Step S101). Document conversion program 11c (analysis part) further causes built-in controller 11 to determine the object conversion mode to be used in the conversion of OOXML objects (Step S102). The object conversion mode has two choices: first is a conversion mode (editing-restriction-based object-conversion mode) in which OOXML objects in an OOXML document are converted into objects according to HTML format (image element and other HTML elements) in accordance with one or more editing restrictions specified in the OOXML document, and second is a conversion mode (ordinary object-conversion mode) in which OOXML objects in an OOXML document are converted into corresponding objects according to HTML format (image element and other HTML elements) as represented in the OOXML document (in other words, converted into objects according to HTML in same or similar representations).

If document conversion program 11c employs a GUI or graphical user interface, switching of these modes can be made by an operator on the GUI by using input unit 17. FIG. 6 illustrates an example of a dialog box or a UI screen (object-conversion-mode selection screen 40) to be displayed on display unit 18. In response to receiving operator's operations to select the object conversion mode on object-conversion-mode selection screen 40 though input unit 17, document conversion program 11c (first conversion part) causes built-in controller 11 to change the object conversion mode according to the operator's selection.

Document conversion program 11c (first conversion part) then causes built-in controller 11 to perform the following operations. If the object conversion mode is set to the editing-restriction-based object-conversion mode (YES in Step S103), built-in controller 11 performs the editing-restriction-based object conversion, which will be descried later, and if the object conversion mode is set to the ordinary object-conversion mode (NO in Step S103), built-in controller 11 converts the OOXML objects in the OOXML document to HTML format as represented in the OOXML document (Step S105).

Built-in controller 11 then creates an HTML document file containing the objects according to HTML format (HTML elements) given by the conversion, and sends the HTML document file to web browsing apparatus 20 (Step S106).

FIG. 7 illustrates detailed operations of the editing-restriction-based object-conversion in Step S104. Document conversion program 11c (analysis part) causes built-in controller 11 to analyze the received OOXML document file (Step S201), and read OOXML objects one by one from the OOXML document (Step S202).

Document conversion program 11c (first conversion part) causes built-in controller 11 to assign the object ID of the OOXML object that was read from the OOXML document, to the variable “idString” representing the id attribute value (idString<-ObjectID) (Step S203), and determine the type of editing restriction set to the OOXML object (Step S204). Document conversion program 11c (first conversion part) then causes built-in controller 11 to convert the OOXML object to HTML format, in accordance with the determined type of editing restriction. On determining that the type of the editing restriction is “read only” or “no changes allowed” (in other words, changes of both formatting and contents of the OOXML object are restricted), built-in controller 11 makes an image from the appearance of the OOXML object, to convert the OOXML object into an image element (Step S205); and assigns the text string representing “read only” to the variable “clString” representing the class attribute value (clString<-RestrictEditing) (Step S206). On determining that the type of the editing restriction is “no formatting changes allowed” (in other words, changes of formatting of the OOXML object are restricted and changes of the contents of the OOXML object are allowed), built-in controller 11 makes an image from the appearance of the OOXML object, to convert the OOXML object into an image element (Step S207); and inserts or adds a text string as the contents of the OOXML object into the all attribute value (Step S208); and assigns the value representing “no formatting changes allowed” to the variable “clString” (clString<-RestrictFormatting) (Step S209). On determining that the type of the editing restriction is “no editing restriction” (in other words, changes of both formatting and contents of the OOXML object are allowed), built-in controller 11 converts the OOXML object into a corresponding HTML element as represented according to OOXML format in the OOXML document (Step S210); and assigns the value representing “no editing restriction” to the variable “clString” (clString<-NoRestriction) (Step S211).

After that, document conversion program 11c (analysis part) causes built-in controller 11 to perform the following processing. Built-in controller 11 adds the id and class attributes and their values to the HTML tag for the HTML element (id=“idString”, class “clString”) (Step S212), and judges whether the OOXML object is the last object in the OOXML document (Step S213). On judging that the OOXML object is not the last. object, built-in controller 11 returns to Step S202 and performs the succeeding processes on the next OOXML object read from the OOXML document, in the same manner.

### Processing of HTML Document File

As illustrated in FIG. 8, in response to receiving an HTML document file from document conversion apparatus 10, built-in controller 21 of web browsing apparatus 20 starts web browser 21b to open the HTML document file and causes display unit 28 to display the HTML document so that a user of the web browsing apparatus 20 can browse and edit the document (Step S301).

Next, document processing program 21c (processing part) causes built-in controller 21 to perform the following processing. Built-in controller 21 monitors operator's operations to edit the HTML document (Step S302), and if detecting no operation to edit the HTML document (NO in Step S302), ends the operations to process the HTML document. In response to detecting operator's operations to edit the HTML document (YES in Step S302), built-in controller 21 judges whether the detected operations are operations to edit an object (HTML element) in the HTML document (Step S303). On judging that the detected operations are operations to edit an HTML element (YES in Step S303), built-in controller 21 processes the HTML element according to the editing operations (Step S304). On judging that the detected operations are not operations to edit an HTML element (NO in Step S303), built-in controller 21 further judges whether the detected operations are operations to edit an attribute value (the class attribute value or the alt attribute value) of an HTML element (Step S305). On judging that the detected operations are operations to edit an attribute value of an HTML element (YES in Step S305), built-in controller 21 changes the attribute value according to the editing operations (Step S306). On judging that the detected operations are not operations to edit an attribute value (YES in Step S305), built-in controller 21 processes the document according to the detected operations (Step S307).

After that, built-in controller 21 judges whether the operator's editing operations have ended (Step S308). On judging that the operator's editing operations have not ended (NO in Step S308), built-in controller 21 returns to Step S203 and performs the succeeding processes on the HTML document file in the same manner. On judging that the operator's editing operations have ended (YES in Step S308), built-in controller 21 sends the revised HTML document file to document conversion apparatus 10 (Step S309).

### HTML to OOXML Conversion

As illustrated in FIG. 9, built-in controller 11 of document conversion apparatus 10 obtains the original office document from storage unit 15 and analyzes the original OOXML. document (Step S401). In response to receiving the revised HTML document file form web browsing apparatus 20, built-in controller 11 analyzes the revised HTML document file (Step S402) and reads objects according HTML format (image elements and other HTML elements) one by one from the revised HTML document file (Step S403). Next, document conversion program 11c (second conversion part) causes built-in controller 21 to perform the following processing. Built-in controller 11 judges whether one of the objects according HTML format (the image elements and other HTML elements) read from the revised HTML document file is a new object that was added to the HTML document (Step S404), for example, by comparing the id attribute values of the objects according HTML format in the revised HTML document with the ObjectID values of the OOXML objects in the original OOXML document.

On judging that the one of the objects according HTML format is a new object that was added to the HTML document (YES in Step S404), built-in controller 11 creates an OOXML object corresponding to the new object so as to add the OOXML object into an OOXML document created from the revised HTML document (Step S405). On judging that the one of the objects according HTML format is not a new object that was added to the HTML document (NO in Step S404), built-in controller 11 changes the contents of the OOXML object corresponding to the one of the objects according HTML format in accordance of the one of the objects according HTML format (Step S406). For example, built-in controller 11 changes the contents of an OOXML object corresponding to an image element read from the revised HTML document file, on the basis of the alt attribute value of the image element. In this process, built-in controller 11 may obtain the contents of the image element by searching for the corresponding object in the original OOXML document file or by analyzing the revised HTML document file. Built-in controller 11 then applies an editing restriction to the OOXML object (Step S407), which will be described later in details.

Built-in controller 11 then judges whether the one of the objects according HTML format is the last object in the revised. HTML document file (Step S408). On judging that the object is not the last one (NO in Step S408), built-in controller 11 returns to Step S403 and performs the succeeding processes on the next object according HTML format in the same manner. On judging that the object is the last one (YES in Step S408), built-in controller 11 creates an OOXML document containing the OOXML objects to which either or both of edits that were made to the contents of the corresponding objects in the HTML document and edits that were made to the attribute data added to the corresponding objects in the HTML document, are applied (in other words, convers the revised HTML document file into an OOXML document file while applying either or both of changes of the contents of the objects and changes of editing restrictions made in the HTML document, to corresponding OOXML objects in the OOXML document file) (Step S409).

FIG. 10 illustrates the steps of editing-restrictions applying operations in Step S407. Document conversion program 11c (second conversion part) causes built-in controller 11 to perform the following operations. Built-in controller 11 determines the restriction-applying mode to be used (Step S501). The restriction-applying mode has three choices: the first is a mode in which all the editing restrictions are allowed to be applied to OOXML objects; the second is a mode in which editing restrictions are allowed to be applied to OOXML objects on condition that the editing-restriction application increases the level of the editing restriction set to the corresponding OOXML object; and the third is a mode in which no editing restrictions are allowed to be applied to OOXML objects. If document conversion program 11c employs a GUI or graphical user interface, the selection of the mode can be made by an operator on the GUI by using input unit 17. FIG. 11 illustrates an example of a dialog box (restriction-applying-mode selection screen 41) which allows an operator to select the restriction-applying mode through input unit 17. In response to operator's selection of the mode in the restriction-applying-mode selection screen 41 through input unit 17, document conversion program 11c (second conversion part) causes built-in controller 11 to change the restriction-applying mode according to the operator's selection.

In the above-described operations, built-in controller 11 causes display unit 18 to display restriction-applying-mode selection screen 41 to prompt an operator to select the restriction-applying mode, but the way to select the restriction-applying mode is not limited to the operations. For example, built-in controller 11 may perform the following operations to determining the restriction-applying mode to be used. Built-in controller 11 prompts an operator to input user information, such as a user ID, in the OOXML to HTML conversion, to conduct user authentication, and further prompts an operator to input user information in the HTML to OOXML conversion, to conduct user authentication, so as to compare two pieces of user information input by the operators. On judging that the two pieces of user information input by the operators do not match, built-in controller 11 causes display unit 18 to display restriction-applying-mode selection screen 41 to prompt the operator to select the restriction-applying mode. On the other hand, on judging that the two pieces of user information input by the operators match, built-in controller 11 automatically selects the first restriction-applying mode.

On judging that the third restriction-applying mode has been set, built-in controller 11 ends the editing-restrictions applying operations. On judging that the first restriction-applying mode has been set, built-in controller 11 applies all the editing restrictions specified in the revised HTML document to OOXML objects in the OOXML document (in other words, applies an editing restriction indicated by the attribute data of each object in the revised HTML document to the corresponding OOXML object) (Step S513), and ends the editing-restrictions applying operations.

On judging that the second restriction-applying mode has been selected in Step S501, built-in controller 11 obtains a corresponding OOXML object from the original OOXML document (Step S502), and obtains information of the editing restriction set to the OOXML object (Step S503) to change the value of the variable “orgRestVal” representing an editing restriction set to the OOXML object, in accordance with the obtained information of the editing restriction. In concrete terms, if no editing restriction is set to the OOXML object, built-in controller 11 assigns 0 to the variable “orgRestVal” (Step S504); if the editing restriction set to the OOXML object is “no formatting changes allowed” (for example, in the case that “w:formatting=“true””, “w:formatting=“on”” or “w:formatting =“1”” is set in the OOXML document), built-in controller 11 assigns 1 to the variable “orgRestVal” (Step S505); and if the editing restriction is “no changes allowed” (for example, in the case that “w:edit=“readOnly”” is set and “permission” is not specified in the OOXML document), built-in controller 11 assigns 2 to the variable “orgRestVal” (Step S506).

Built-in controller 11 then obtains an image element or HTML element corresponding to the OOXML object, from the revised HTML document (Step S507) and obtains the value of the class attribute of the element (Step S508) to change the value of the variable “newRestVal” representing an editing restriction set to the image element or HTML element in accordance with the obtained class attribute value. In concrete terms, if the class attribute value indicates “no editing restriction” (the value includes “NoRestriction”), built-in controller 11 assigns 0 to the variable “newRestVal” (Step S509); if the class attribute value indicates “no formatting changes allowed” (the value includes “RestrictFormatting”), built-in controller 11 assigns 1 to the variable “newRestVal” (Step S510); and if the class attribute value indicates “no changes allowed” (the value includes “RestrictEditing”), built-in controller 11 assigns 2 to the variable “newRestVal” (Step S511).

Built-in controller lit then compares the value of “orgRestVal” with the value of “newRestVal” (Step S512). On judging that the value of “orgRestVal” is not less than the value of “newRestVal” (NO in Step S512), built-in controller 11 ends the editing-restrictions applying operations without applying the editing restriction set to the image element or HTML element to the OOXML object. On judging that the value of “orgRestVal” is less than the value of “newRestVal” (in other words, the editing restriction set to the image element or HTML element is stricter than that set to the OOXML object) (YES in Step S512), built-in controller 11 applies the editing restriction set to the image element or HTML element to the OOXML object (Step S513) and ends the editing-restrictions applying operations.

For example, if no editing restriction is set to the OOXML object and the editing restriction set to the image element or HTML element indicates “no formatting changes allowed” (“RestrictFormatting”) or “no changes allowed” (“RestrictEditing”), built-in controller 11 specifies “w:formatting=“true””, “w:formatting “on”” or “w:formatting “1”” (in the case that “no formatting changes allowed” is set to the image element or HTML element), or “w:edit=“readOnly”” (in the case that “no changes allowed” is set to the image element or HTML element), for the editing restriction on the OOXML object. For another example, if the editing restriction set to the OOXML object indicates “no formatting changes allowed” (“w:formatting=“true””, “w:formatting=“on”” or “w:formatting =“1””) and the editing restriction set to the image element or HTML element indicates “no changes allowed” (“RestrictEditing”), built-in controller 11 specifies “w:edit=“readOnly””, for the editing restriction on the OOXML object.

As described in the present embodiment, in the convection of an office document created by an office suite application, such as an OOXML, or ODF document, to an HTML document in the format supported by web browsers, built-in controller 11 of document conversion apparatus 10 performs the following operations on condition that the OOXML to HTML object-conversion mode is set to the editing-restriction-based object-conversion mode. Built-in controller 11 converts one or more editing-restricted OOXML objects in the office document into one or more image elements, by making an image form the appearance of each of the one or more editing-restricted OOXML objects. On finding a text object in the one or more editing-restricted OOXML objects, built-in controller 11 adds the contents of the text object (text string) to the alt attribute value of an image element converted from the text object. Built-in controller 11 further converts the other OOXML objects (OOXML objects for which no editing restrictions are set) into corresponding HTML elements. With such operations, built-in controller 11 can convert an office document into an HTML document which maintains one or more formatting restrictions specified in the original OOXML document and allows a user of a web browser to edit the contents of one or more formatting-change-restricted objects.

Further, to each of image elements and other HTML elements converted from OOXML objects, built-in controller 11 adds an id attribute and a class attribute so as to correlate each OOXML object and the corresponding image or HTML element by using the id attribute and correlate an editing restriction between each OOXML object and the corresponding image or HTML element by using the class attribute. Further, when a new object is added to the HTML document converted from the OOXML document, or when an editing restriction set to an object is changed in the HTML document, the class attribute value of the corresponding element in the HTML document is used to set or change the editing restriction on the object. With such operations, built-in controller 11 can convert the HTML document that was revised, into an office document, while applying operations to add a new object that were made in the HTML document and operations to change editing restrictions that were made in the HTML document, to the OOXML document given by the conversion.

Hereinafter, a description is given of the document conversion method in details, with reference to a concrete example.

FIG. 12 illustrates an example of the folder structure of an OOXML document file created by an office suite application, such as Microsoft Word. An OOXML document file is a zip file or a package, containing parts and relationships parts that define the relationships between the parts. In concrete terms, an OOXML document contains a “[Content_Types].xml” file, a “_rels” folder, a “docProps” folder, and a “word” folder. The “word” folder contains files and folders representing the contents of the document, such as a “document.xml” file, a “fontTable.xml” file, a “comments.xml” file, a “settings.xml” file, a “style.xml” file, a “webSetting.xml” file, a “_rels” folder and a “theme” folder. The details of the specifications of OOXML format is given in the web site “http://www.ccma-international.org/publications/standards/Ecma-376.htm”.

Files in the “word” folder in an OOXML document file created by one of office suite applications 11b, are described in a markup language. In the descriptions in the markup language, the data structure, the appearance of the document and meanings are defined by using codes so-called as tags (tokens). FIG. 13 illustrates a part of descriptions in the markup language, indicating editing restrictions, in the “settings.xml” file in an OOXML document file. The line enclosed with a broken line “<w:documentProtection . . . >” in the descriptions is an element defining editing restrictions for the document. In concrete terms, the description “w:enforcement=“1”” indicates that protection settings of the document are enforced. The attribute “w:edit” represents editing restrictions to be specified to the document, where “w:edit=“readOnly”” indicates that no changes (no edits) are allowed. This example gives the descriptions which allows no editing restrictions on the whole document, but an element including a tag, such as “permission”, may be used in the document in order to specify an element to which no editing restriction is applied. FIG. 14A illustrates another example of a part of descriptions in the markup language, in the “settings.xml” file in an OOXML document file, and the “<w:formatting>” element in the line enclosed with a broken line represents formatting restrictions, FIG. 14B illustrates an example of a part of descriptions in the markup language, in the “style.xml” file in the OOXML document file, and the “<w:locked/>” attribute enclosed with a broken line represents whether a formatting restriction is allowed to be applied or not. That is, if formatting restrictions are set to the document (in the case that the value of the “<w:formatting>” attribute is set to “true”, “on” or “1”), formatting changes are allowed only for the style including no “<w:locked/>” element. Therefore, document conversion program 11c (analysis part) causes, when being executed, built-in controller 11 to check these descriptions in the OOXML document file to determine editing restrictions specified in the OOXML document file.

FIGS. 15A to 15D illustrate concrete examples of an OOXML document and an HTML document converted from the OOXML document. FIGS. 15A and 15B illustrate the OOXML document before revisions and codes of the “document.xml” file contained in the OOXML document file. FIGS. 15C and 15D illustrate the HTML document converted from the OOXML document and revised, and codes of the corresponding “document.html” file. As illustrated in FIGS. 15C and 15D, the image element representing the title “Introduction:” in the HTML document includes the id attribute set to “1” and the class attribute set to “RestrictFormatting”. It means that formatting changes of the text object corresponding to the image element are not allowed, but changes of the contents of the text object corresponding to the image element is allowed, by a change of the codes of the “document.html” file (change of the value of the alt attribute of the image element). Further, the element representing the text “The characteristics of color are made up of . . . and value is measured on the vertical axis.” in the HTML document includes the id attribute set to “2” and the class attribute set to “NoRestriction”. It means that the formatting and the contents of this part are allowed to be changed, by a change of the codes of the “document.html” file.

It should be noted that the present invention should not be limited to the above-described embodiments, and the constitution and control operations of the document conversion apparatus and the system including the document conversion apparatus can be modified suitably, unless the modification deviates from the intention of the present invention.

For example, the above-described embodiment gave operations to add an id attribute and a class attribute to an image element or an HTML element, but the operations to add an id attribute may be omitted in the case that objects according to HTML format (an image element or HTML element) can be correlated with the corresponding OOXML objects by using the order, size or construction of the objects.

Further, the above-described embodiment gave an OOXML document as an example of a document in first format, created by one of office suite applications 11b, but the first format is not limited to the OOXML format. The above-described document conversion method may be applied similarly to ODF documents or documents in other formats.

Further, the above-described embodiment gave an HTML document as an example of a document in second format, supported by web browsers 21b, but the second format is not limited to the HTML format. The above-described document conversion method may be applied similarly to documents in other markup languages.

The present invention is applicable to document conversion apparatuses for converting a document between first format supported by office suite applications, such as OOXML or a ODF format, and second format supported by web browsers, such as HTML format; non-transitory computer-readable recording media each storing a document conversion program to be executed in the document conversion apparatus; and document conversion methods for use in a system including the document conversion apparatus.

Although embodiments of the present invention have been described and illustrated in detail, it is clearly understood that the same is by way of illustration and example only and not limitation, the scope of the present invention should be interpreted by terms of the appended claims.sss

1. A document conversion apparatus for converting a document between first format supported by office suite applications and second format supported by web browsers, the document conversion apparatus comprising:
a hardware processor; and
a storage unit operatively connected to the hardware processor, storing a computer-readable program comprising instructions which, when executed by the hardware processor, cause the hardware processor to perform operations comprising:
in response to obtaining a first document in the first format created by an office suite application, analyzing the first document to determine objects according to the first format contained in the first document and to read one or more editing restrictions specified in the first document;
performing first conversion, including
converting the objects according to the first format into objects according to the second format, in accordance with the one or more editing restrictions read from the first document,
creating a second document in the second format, containing the objects according to the second format,
adding, to each of the objects contained in the second document, attribute data representing an editing restriction set to a corresponding object according to the first format in the first document, on a basis of the one or more editing restrictions read from the first document, and
outputting the second document to an apparatus configured to process a document in the second format; and
in response to obtaining the second document revised by the apparatus, performing second conversion, including
analyzing the revised second document to create objects according to the first format from objects contained in the revised second document and to apply either or both of an edit that was made to each of one or more objects in the second document and an edit that was made to the attribute data added to the each of one or more objects in the second document, to a corresponding one of the objects according to the first format created from the revised second document, and
creating a document in the first format, containing the objects according to the first format created from the revised second document.

2. The document conversion apparatus of claim 1,
wherein the performing first conversion, includes
on judging that one or more editing restrictions are specified in the first document,
converting one or more editing-restricted objects among the objects according to the first format contained in the first document, into one or more image objects, by making an image form an appearance of each of the one or more editing-restricted objects, and
converting the other objects among the objects according to the first format contained in the first document, into corresponding objects according to the second format.

3. The document conversion apparatus of claim 2,
wherein the document conversion apparatus further comprises a display and an input device, and
the performing first conversion, includes
causing the display to display a first conversion mode and a second conversion mode so as to allow an operator to select one of the first conversion mode and the second conversion mode through the input device, where the first conversion mode is a mode in which the hardware processor converts the objects according to the first format into objects according to the second format while applying the one or more editing restrictions specified in the first document to the objects according to the second format, and the second conversion mode is a mode in which the hardware processor converts the objects according to the first format into objects according to the second format without applying the one or more editing restrictions specified in the first document to the objects according to the second format, and
on receiving an operator's selection of the first conversion mode, converting the one or more editing-restricted objects into one or more image objects.

4. The document conversion apparatus of claim 2,
wherein the performing second conversion, includes
on creating the objects according to the first format from the objects contained in the revised second document, creating one or more editing-restricted objects in accordance with an existence of an image object corresponding to each of the objects according to the first format and an existence of a change of the attribute data of the image object.

5. The document conversion apparatus of claim 2,
wherein the performing second conversion, includes
comparing a first editing restriction set to each of the objects according to the first format contained in the first document with a second editing restriction indicated by the attribute data added to an object according to the second format or an image object in the revised second document, corresponding to the each of the objects according to the first format contained in the first document, and
applying the second editing restriction to each of the objects according to the first format created from the revised second document on condition that the second editing restriction is stricter than the first editing restriction.

6. The document conversion apparatus of claim 1,
wherein the document conversion apparatus further comprises a display and an input device, and
the performing second conversion, includes
causing the display to display a first restriction-applying mode, a second restriction-applying mode and a third restriction-applying mode so as to allow an operator to select one of the first to third restriction-applying modes through the input device, where the first restriction-applying mode is a mode in which an editing restriction indicated by the attribute data of each object according to the second format in the revised second document is allowed to be applied to a corresponding object according to the first format in the second conversion, the second restriction-applying mode is a mode in which an editing restriction indicated by the attribute data of each object according to the second format in the revised second document is allowed to be applied to a corresponding object according to the first format in the second conversion on condition that application of the editing restriction indicated by the attribute data increases a level of the editing restriction set to the corresponding object according to the first format, and the third restriction-applying mode is a mode in which an editing restriction indicated by the attribute data of each object according to the second format in the revised second document is not allowed to be applied to a corresponding object according to the first format in the second conversion.

7. The document conversion apparatus of claim 6,
wherein the performing second conversion, includes
on judging that a person who converted the first document into the second document by the first conversion and a person who is converting the revised second document to the first format by the second conversion match, selecting the first restriction-applying mode.

8. The document conversion apparatus of claim 1,
wherein the first format is OOXML format or ODF format,
the second format is HTML format, and
the attribute data includes a class attribute.

9. A non-transitory computer-readable recording medium storing a document conversion program to be executed in a document conversion apparatus for converting a document between first format supported by office suite applications and second format supported by web browsers, the program comprising instructions which, when executed by a hardware processor of the document conversion apparatus, cause the hardware processor to perform operations comprising:
in response to obtaining a first document in the first format created by an office suite application, analyzing the first document to determine objects according to the first format contained in the first document and to read one or more editing restrictions specified in the first document;
performing first conversion, including
converting the objects according to the first format into objects according to the second format, in accordance with the one or more editing restrictions read from the first document,
creating a second document in the second format, containing the objects according to the second format,
adding, to each of the objects contained in the second document, attribute data representing an editing restriction set to a corresponding object according to the first format in the first document, on a basis of the one or more editing restrictions read from the first document, and
outputting the second document to an apparatus configured to process a document in the second format; and
in response to obtaining the second document revised by the apparatus, performing second conversion, including
analyzing the revised second document to create objects according to the first format from objects contained in the revised second document and to apply either or both of an edit that was made to each of one or more objects in the second document and an edit that was made to the attribute data added to the each of one or more objects in the second document, to a corresponding one of the objects according to the first format created from the revised second document, and
creating a document in the first format, containing the objects according to the first format created from the revised second document.

10. The non-transitory computer-readable recording medium of claim 9,
wherein the performing first conversion, includes
on judging that one or more editing restrictions are specified in the first document,
converting one or more editing-restricted objects among the objects according to the first format contained in the first document, into one or more image objects, by making an image form an appearance of each of the one or more editing-restricted objects, and
converting the other objects among the objects according to the first format contained in the first document, into corresponding objects according to the second format.

11. The non-transitory computer-readable recording medium of claim 10,
wherein the performing first conversion, includes
causing a display of the document conversion apparatus to display a first conversion mode and a second conversion mode so as to allow an operator to select one of the first conversion mode and the second conversion mode through an input device of the document conversion apparatus, where the first conversion mode is a mode in which the hardware processor converts the objects according to the first format into objects according to the second format while applying the one or more editing restrictions specified in the first document to the objects according to the second format, and the second conversion mode is a mode in which the hardware processor converts the objects according to the first format into objects according to the second format without applying the one or more editing restrictions specified in the first document to the objects according to the second format, and
on receiving an operator's selection of the first conversion mode, converting the one or more editing-restricted objects into one or more image objects.

12. The non-transitory computer-readable recording medium of claim 10,
wherein the performing second conversion, includes
on creating the objects according to the first format from the objects contained in the revised second document, creating one or more editing-restricted objects in accordance with an existence of an image object corresponding to each of the objects according to the first format and an existence of a change of the attribute data of the image object.

13. The non-transitory computer-readable recording medium of claim 10,
wherein the performing second conversion, includes
comparing a first editing restriction set to each of the objects according to the first format contained in the first document with a second editing restriction indicated by the attribute data added to an object according to the second format or an image object in the revised second document, corresponding to the each of the objects according to the first format contained in the first document, and
applying the second editing restriction to each of the objects according to the first format created from the revised second document on condition that the second editing restriction is stricter than the first editing restriction.

14. The non-transitory computer-readable recording medium of claim 9,
wherein the performing second conversion, includes
causing a display of the document conversion apparatus to display a first restriction-applying mode, a second restriction-applying mode and a third restriction-applying mode so as to allow an operator to select one of the first to third restriction-applying modes through an input device of the document conversion apparatus, where the first restriction-applying mode is a mode in which an editing restriction indicated by the attribute data of each object according to the second format in the revised second document is allowed to be applied to a corresponding object according to the first format in the second conversion, the second restriction-applying mode is a mode in which an editing restriction indicated by the attribute data of each object according to the second format in the revised second document is allowed to be applied to a corresponding object according to the first format in the second conversion on condition that application of the editing restriction indicated by the attribute data increases a level of the editing restriction set to the corresponding object according to the first format, and the third restriction-applying mode is a mode in which an editing restriction indicated by the attribute data of each object according to the second format in the revised second document is not allowed to be applied to a corresponding object according to the first format in the second conversion.

15. The non-transitory computer-readable recording medium of claim 14,
wherein the performing second conversion, includes
on judging that a person who converted the first document into the second document by the first conversion and a person who is converting the revised second document to the first format by the second conversion match, selecting the first restriction-applying mode.

16. The non-transitory computer-readable recording medium of claim 9,
wherein the first format is OOXML format or ODF format,
the second format is HTML format, and
the attribute data includes a class attribute.

17. A document conversion method for use in a system including a document conversion apparatus for converting a document between first format supported by office suite applications and second format supported by web browsers, the method comprising:
in response to obtaining a first document in the first format created by an office suite application, analyzing the first document, by a hardware processor of the document conversion apparatus, to determine objects according to the first format contained in the first document and to read one or more editing restrictions specified in the first document;
performing first conversion by the hardware processor of the document conversion apparatus, including
converting the objects according to the first format into objects according to the second format, in accordance with the one or more editing restrictions read from the first document,
creating a second document in the second format, containing the objects according to the second format, and
adding, to each of the objects contained in the second document, attribute data representing an editing restriction set to a corresponding object according to the first format in the first document, on a basis of the one or more editing restrictions read from the first document;
outputting, by the hardware processor of the document conversion apparatus, the second document to an apparatus configured to process a document in the second format; and
in response to obtaining the second document revised by the apparatus, performing second conversion by the hardware processor of the document conversion apparatus, including
analyzing the revised second document to create objects according to the first format from objects contained in the revised second document and to apply either or both of an edit that was made to each of one or more objects in the second document and an edit that was made to the attribute data added to the each of one or more objects in the second document, to a corresponding one of the objects according to the first format created from the revised second document, and
creating a document in the first format, containing the objects according to the first format created from the revised second document.

18. The document conversion method of claim 17,
wherein the system further includes a browsing apparatus configured to process a document in the second format, and
the method further comprising
in response to receiving the second document from the document conversion apparatus, causing, by a hardware processor of the browsing apparatus, a display of the browsing apparatus to display the second document so as to allow an operator to edit the second document,
receiving, by the hardware processor of the browsing apparatus, operator's operations to edit either or both of one or more object contained in the second document and the attribute data of one or more object contained in the second document, to process the second document in accordance with the received operator's operations and to create a revised second document, and
sending, by the hardware processor of the browsing apparatus, the revised second document to the document conversion apparatus.

19. The document conversion method of claim 17,
wherein the performing first conversion, includes
on judging that one or more editing restrictions are specified in the first document,
converting one or more editing-restricted objects among the objects according to the first format contained in the first document, into one or more image objects, by making an image form an appearance of each of the one or more editing-restricted objects, and
converting the other objects among the objects according to the first format contained in the first document, into corresponding objects according to the second format.

20. The document conversion method of claim 19,
wherein the performing first conversion, includes
causing a display of the document conversion apparatus to display a first conversion mode and a second conversion mode so as to allow an operator to select one of the first conversion mode and the second conversion mode through an input device of the document conversion apparatus, where the first conversion mode is a mode in which the hardware processor converts the objects according to the first format into objects according to the second format while applying the one or more editing restrictions specified in the first document to the objects according to the second format, and the second conversion mode is a mode in which the hardware processor converts the objects according to the first format into objects according to the second format without applying the one or more editing restrictions specified in the first document to the objects according to the second format, and
on receiving an operator's selection of the first conversion mode, converting the one or more editing-restricted objects into one or more image objects.

21. The document conversion method of claim 19,
wherein the performing second conversion, includes
on creating the objects according to the first format from the objects contained in the revised second document, creating one or more editing-restricted objects in accordance with an existence of an image object corresponding to each of the objects according to the first format and an existence of a change of the attribute data of the image object.

22. The document conversion method of claim 19,
wherein the performing second conversion, includes
comparing a first editing restriction set to each of the objects according to the first format contained in the first document with a second editing restriction indicated by the attribute data added to an object according to the second format or an image object in the revised second document, corresponding to the each of the objects according to the first format contained in the first document, and
applying the second editing restriction to each of the objects according to the first format created from the revised second document on condition that the second editing restriction is stricter than the first editing restriction.

23. The document conversion method of claim 17,
wherein the performing second conversion, includes
causing a display of the document conversion apparatus to display a first restriction-applying mode, a second restriction-applying mode and a third restriction-applying mode so as to allow an operator to select one of the first to third restriction-applying modes through an input device of the document conversion apparatus, where the first restriction-applying mode is a mode in which an editing restriction indicated by the attribute data of each object according to the second format in the revised second document is allowed to be applied to a corresponding object according to the first format in the second conversion, the second restriction-applying mode is a mode in which an editing restriction indicated by the attribute data of each object according to the second format in the revised second document is allowed to be applied to a corresponding object according to the first format in the second conversion on condition that application of the editing restriction indicated by the attribute data increases a level of the editing restriction set to the corresponding object according to the first format, and the third restriction-applying mode is a mode in which an editing restriction indicated by the attribute data of each object according to the second format in the revised second document is not allowed to be applied to a corresponding object according to the first format in the second conversion.

24. The document conversion method of claim 23,
wherein the performing second conversion, includes
on judging that a person who converted the first document into the second document by the first conversion and a person who is converting the revised second document to the first format by the second conversion match, selecting the first restriction-applying mode.

25. The document conversion method of claim 17,
wherein the first format is OOXML format or ODF format,
the second format is HTML format, and
the attribute data includes a class attribute.
